(19) United States
(12) Patent Application Publication
(10) Pub. No.: US 2026/0168160 A1
(43) Pub. Date: Jun. 18, 2026

(54) OPENING UNIT AND LAUNDRY TREATING APPARATUS EQUIPPED WITH OPENING UNIT

(71) Applicants: LG ELECTRONICS INC., Seoul (KR); KOREA NAKAGAWA ELEC. IND. CO., LTD., Changwon-si, Gyeongsangnam-do (KR)

(72) Inventors: Jaehoon CHOI, Seoul (KR); Kichul CHO, Seoul (KR); Heuido HAN, Gimhae-si (KR)

(73) Assignees: LG ELECTRONICS INC., Seoul (KR); KOREA NAKAGAWA ELEC. IND. CO., LTD., Changwon-si, Gyeongsangnam-do (KR)

(21) Appl. No.: 19/125,179

(22) PCT Filed: Dec. 8, 2022
(86) PCT No.: PCT/KR2022/019917

§ 371 Date: Apr. 28, 2025

(30) Foreign Application Priority Data
Nov. 30, 2022 (KR) 10-2022-0164591

(51) Int. Cl. D06F 39/14

(52) U.S. Cl. CPC D06F 39/14

(57) ABSTRACT

The present application relates to a laundry treating apparatus comprising: a cabinet having an input port; a treatment unit provided inside the cabinet so as to provide a space for storing clothes; a door provided in the cabinet to open and close the input port; and a door opening unit that is provided to be withdrawable from the cabinet and changes the input port from a closed state to an open state by pushing the door in a direction away from the input port, wherein, when the door moves in the direction of closing the input port and an external force is inputted to the door opening unit, the door opening unit moves toward the inside of the cabinet.

### TECHNICAL FIELD

The present disclosure relates to an opening unit and a laundry treating apparatus equipped with the opening unit.

### BACKGROUND

A laundry treating apparatus is a general term for apparatuses that wash or dry an object or remove odor or wrinkles from the object.

The existing laundry treating apparatuses are constructed to include a treating portion that provides a space for accommodating the object (laundry or the like), an inlet that is disposed in a cabinet to enable insertion of the object into the treating portion or withdrawal of the object from the treating portion, and a door disposed on the cabinet to enable opening and closing of the inlet.

The existing laundry treating apparatuses are equipped with a door lock to prevent the inlet from being opened when the laundry treating apparatuses are operated for laundry treatment (the washing, the drying, the wrinkle removal, or the odor removal). When the operation of the laundry treating apparatus is ended, the door lock is controlled to release coupling of the door and the cabinet, so that when the operation of the laundry treating apparatus is ended, a user is able to open the inlet.

That is, in the existing laundry treating apparatuses, even after the laundry treatment process is ended, the door maintains the inlet closed, which may cause problems from a sanitary perspective because it increases humidity inside the treating portion where the object is accommodated.

Among the existing laundry treating apparatuses, there is one equipped with an opening unit that pushes the door for the door to open the inlet when the operation of the laundry treating apparatus is completed (Publication No. 10-2020-0059015).

The existing opening unit is able to solve the problem of the laundry treating apparatus without the opening unit in that it controls the door to open the inlet, but has a disadvantage of low durability because it is likely to be damaged when an external force is input to the opening unit.

That is, when the user pushes the door in a direction in which the inlet is located while the opening unit is in a state of opening the inlet (a state in which a pin of the opening unit supports the door to form a gap between the door and the inlet), there is a possibility that the opening unit (the pin, a gear that controls a location of the pin, and the like) that maintains a state of protruding from the cabinet may be damaged.

In addition, when the laundry treating apparatus is not installed on a horizontal floor surface, the gap between the door and the inlet may become too great when the opening unit is in operation (the door may become in a state of widely opening the inlet). When the gap between the door and the inlet is too great, it is advantageous for drying inside of the treating portion, but it may also cause a problem where external foreign substances are introduced into the treating portion.

### SUMMARY

### Technical Problem

The present disclosure is to provide an opening unit that pushes a door such that an inlet opens when a preset time point is reached, and a laundry treating apparatus equipped with the opening unit.

In addition, the present disclosure is to provide an opening unit that may minimize durability degradation caused by an unintended external force, and a laundry treating apparatus equipped with the opening unit.

In addition, the present disclosure is to provide an opening unit that may minimize an amount of foreign substances flowing into a treating portion by maintaining a gap between a door and an inlet, and a laundry treating apparatus equipped with the opening unit.

### Technical Solutions

The present disclosure relates to a laundry treating apparatus including a cabinet having an inlet defined therein, a treating portion disposed inside the cabinet and constructed to provide a space where laundry is accommodated, a door that is disposed on the cabinet and opens and closes the inlet, and a door opener that is constructed be withdrawable from the cabinet and pushes the door in a direction away from the inlet to change a state of the inlet from a closed state to an open state.

When the inlet is in the open state, the door opener may maintain a state of being withdrawn from the cabinet.

When the door moves in a direction of closing the inlet and an external force is input to the door opener, the door opener may move into the cabinet.

The laundry treating apparatus may further include a connecting portion that is constructed to connect the door with the cabinet with a preset fastening force and allows the opening of the inlet when an external force equal to or greater than the fastening force is input to the door, and the door opener may supply an opening force set to be greater than the fastening force to the door.

When a magnitude of the external force transmitted to the door opener via the door is greater than the opening force, the door opener may move into the cabinet.

The laundry treating apparatus may further include a door mounting groove defined in the cabinet to define a space where one surface of the door is accommodated, wherein the inlet is located in the door mounting groove, and the door opener may be located in the door mounting groove.

The laundry treating apparatus may further include a connecting portion receiving hole defined to extend through the cabinet and positioned in the door mounting groove, and a detachable portion disposed inside the cabinet and detachably coupled to the connecting portion inserted into the connecting portion receiving hole.

The door opener may include a gear body rotatably fixed inside the cabinet, a protrusion positioned on a rotational shaft of the gear body, rotatable by the gear body, and protruding from the gear body toward the cabinet, an operating portion extending through the cabinet and coupled to the protrusion, wherein the operating portion reciprocates between a first point causing the door to open the inlet and a second point causing the door to maintain the inlet closed based on a rotation direction of the protrusion, and a fastening portion that is constructed to couple the protrusion to the gear body and allows idling of the protrusion when an external force equal to or greater than a preset magnitude is input to the protrusion.

The laundry treating apparatus may further include a connecting portion that is constructed to connect the door with the cabinet with a preset fastening force and allows the opening of the inlet when an external force equal to or greater than the fastening force is input to the door, and the fastening portion may supply an opening force (a pushing force) set greater than the fastening force to the door.

When a force equal to or smaller than the opening force is input to the operating portion, the fastening portion may prevent the idling of the protrusion, and when a force greater than the opening force is input to the operating portion, the fastening portion may allow the idling of the protrusion.

The fastening portion may include a mounting groove defined in one surface of the gear body, a fastening body where the protrusion body is fixed and rotatable within the mounting groove, a fastening protrusion composed of multiple protrusions arranged along edges of the fastening body, and a fastening groove composed of grooves arranged along edges of the mounting groove to provide spaces where the protrusions in the fastening protrusion are accommodated, wherein the number of grooves is greater than the number of protrusions in the fastening protrusion.

The protrusions in the fastening protrusion may include six protrusions equally spaced apart from each other along the edges of the fastening body, and the grooves in the fastening groove may include 18 grooves equally spaced apart from each other along the edges of the mounting groove.

The laundry treating apparatus may further include a slit defined to extend through fastening body and positioned between the protrusion body and the fastening protrusion.

The laundry treating apparatus may further include a door mounting groove defined in the cabinet to define a space where one surface of the door is accommodated, wherein the inlet is located in the door mounting groove, and a panel through-hole defined to extend through the cabinet and positioned in the door mounting groove, wherein one end of the operating portion is withdrawable from the panel through-hole.

The laundry treating apparatus may further include a gap maintainer that is disposed on at least one of the door and the cabinet and maintains a gap between the inlet and the door.

The gap maintainer may include a spring fixed to the door, a mounting body that is fixed to a free end of the spring and reciprocates between the door and the cabinet, and a permanent magnet fixed to one surface of the mounting body facing the cabinet, and a pushing distance of the door opener for pushing the door is set to a length that prevents the permanent magnet from separating from the cabinet.

### Advantageous Effects

The present disclosure provides the opening unit that pushes the door such that the inlet opens when the preset time point is reached, and the laundry treating apparatus equipped with the opening unit.

In addition, the present disclosure provides the opening unit that may minimize the durability degradation caused by the unintended external force, and the laundry treating apparatus equipped with the opening unit.

In addition, the present disclosure provides the opening unit that may minimize the amount of foreign substances flowing into the treating portion by maintaining the gap between the door and the inlet, and the laundry treating apparatus equipped with the opening unit.

### BRIEF DESCRIPTION OF THE DRAWINGS

FIGS. 1 and 2 illustrate an example of a laundry treating apparatus equipped with an opening unit.

FIGS. 3 and 4 illustrate an example of a door and a door lock.

FIGS. 5, 6, and 7 illustrate an examples of an opening unit.

FIG. 8 illustrates an example of an actuator equipped in an opening unit.

FIGS. 9 and 10 illustrate an example of an operation process of an opening unit.

FIG. 11 illustrates an example of a gap maintainer.

FIG. 12 illustrates states of an opening unit and a gap maintainer when a door closes an inlet.

FIG. 13 illustrates states of an opening unit and a gap maintainer when a door opens an inlet.

### BEST MODEL

Hereinafter, a preferred embodiment of a laundry treating apparatus and a method for controlling the same will be described in detail with reference to the attached drawings.

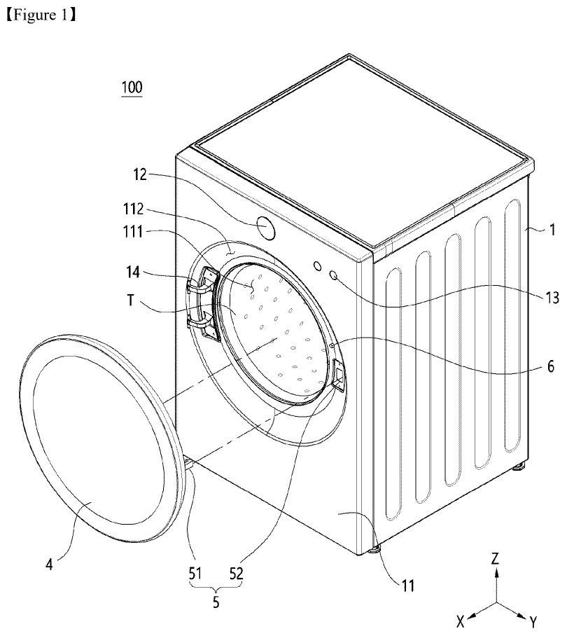

As illustrated in FIG. 1, a laundry treating apparatus 100 includes a cabinet 1, and a treating portion T disposed inside the cabinet to perform washing or drying, or removal of odor or wrinkles of an object (laundry or the like).

The cabinet 1 includes a front panel 11 made of a metal material and forming a front surface of the laundry treating apparatus, and an inlet 111 in communication with the treating portion T is defined in the front panel 11.

The inlet 111 is constructed to be opened and closed by a door 4. FIG. 1 illustrates a case in which the door 4 is pivotably coupled to the cabinet 1 as an example. In this case, the door 4 may be coupled to the cabinet 1 via a hinge 14 fixed to the front panel 11.

The front panel 11 may have a door mounting groove 112 defined therein that defines a space in which one surface of the door 4 (one surface of the door facing the front panel) is accommodated. In this case, it is preferable that the inlet 111 is positioned in the door mounting groove 112.

The front panel 11 may have a control panel 12, and the control panel 12 may be constructed to include an input unit that receives a control command from a user and a display that displays information regarding operation or control of the laundry treating apparatus.

When the laundry treating apparatus 100 is constructed as an apparatus for drying the laundry, the treating portion T may be composed of a drum rotatably disposed inside the cabinet 1, and a heat exchanger that supplies air to the drum to remove moisture from the laundry.

In one example, when the laundry treating apparatus 100 is constructed as an apparatus for removing the odor or the wrinkles from the laundry, the treating portion T may be composed of a treatment chamber disposed inside the cabinet and in which the laundry is accommodated, a steam generator that supplies steam to the chamber, and a heat exchanger that supplies air to the chamber to exchange heat with the laundry.

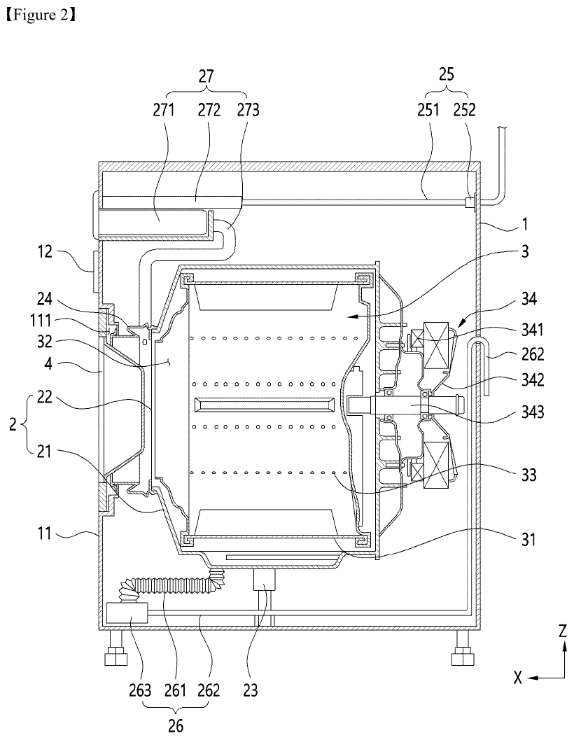

FIG. 2 illustrates a case in which the laundry treating apparatus 100 is constructed as an apparatus for washing the laundry as an example.

As shown in FIG. 2, the treating portion T may be constructed to include a tub 2 disposed inside the cabinet 1 to store water therein, and a drum 3 rotatably disposed inside the tub 2 to store the laundry therein.

The tub 2 includes a tub body 21 fixed inside the cabinet 1. The tub body 21 may be formed in a hollow cylindrical shape, and a tub inlet 22 may be defined in a front surface of the tub body 21. The tub inlet 22 is connected to the inlet 111 via a gasket 24.

The tub body 21 may be fixed inside the cabinet 1 via a tub support 23, and the tub support 23 may be composed of a spring connecting an upper circumferential space of the tub body 21 to the cabinet 1, and a damper connecting a lower circumferential space of the tub body 21 to the cabinet 1.

The drum 3 includes a drum body 31 rotatably fixed inside the tub body 21. The drum body 31 may be formed in a hollow cylindrical shape, and a drum inlet 32 is defined in a front surface of the drum body 31.

The drum inlet 32 is connected to the tub inlet 22 and the inlet 111 via the gasket 24 having a substantially cylindrical shape. Therefore, the user may put the laundry into the drum body 31 when the inlet 111 is opened.

Multiple communication holes 33 are defined in a circumferential surface or the like of the drum body 31. The communication holes 33 are a means for discharging liquid inside the drum body 31 to the tub body 21 or for introducing liquid inside the tub body 21 into the drum body 31.

The drum body 31 may be rotatably fixed inside the tub body 21 via a driver 34.

The driver 34 may be constructed to include a stator 341 that is fixed to a rear surface of the tub body 21 and generates a rotating magnetic field, a rotor 342 that is positioned outside the tub body 21 and rotates by the rotating magnetic field, and a rotational shaft 343 that extends through the tub body 21 and connects the rotor and the drum body to each other.

The tub body 21 may receive water via a water supply 25, and water inside the tub body 21 may be discharged to the outside of the cabinet 1 via a drainage 26.

The water supply 25 may be constructed to include a water supply pipe 251 connecting a water source with the tub body 21, and a water supply valve 252 that controls opening and closing of the water supply pipe 251 in response to a control signal of a controller (not shown).

FIG. 2 illustrates a case in which a detergent supply 27 is coupled with the water supply 25. The detergent supply 27, as a means for supplying detergent to the tub body 21, may be constructed to include a drawer 271 that is extendable from the cabinet 1 and provides a space where the detergent is stored, a water supply nozzle 272 that supplies water supplied from the water supply pipe 251 to the drawer 271, and a detergent supply pipe 273 that guides water and the detergent discharged from the drawer to the gasket 24.

The drainage 26 may be constructed to include a pump 263 fixed inside the cabinet 1, a first drainage pipe 261 that guides water inside the tub body 21 to the pump 263, and a second drainage pipe 262 that guides water discharged from the pump 263 to the outside of the cabinet 1.

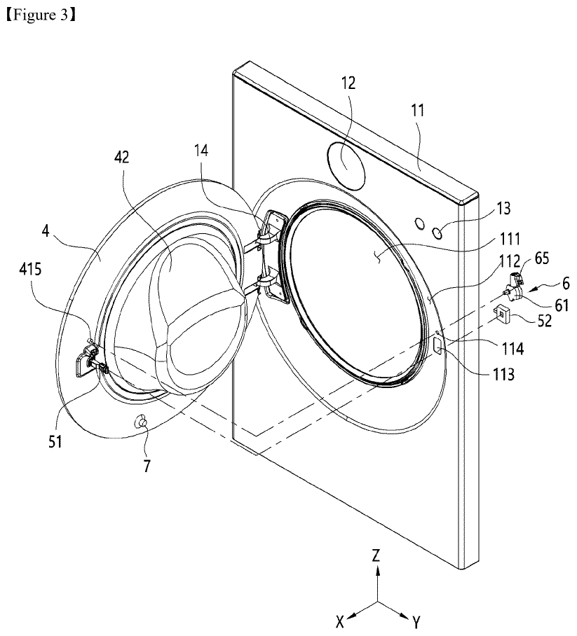

As shown in FIG. 3, the door 4 may be fixed to the front panel 11 via a door lock 5. The door lock 5 is a means for restraining the door 4 to the cabinet 1 or releasing the restraint of the door 5 in response to a control signal of the controller (not shown).

The door lock 5 may be constructed to include a connecting portion 51 protruding from the door 4, and a detachable portion 52 disposed inside the cabinet 1 and detachably coupled to the connecting portion 51.

The connecting portion 51 may be formed as a bar protruding from the door 4 toward the front panel 11 and a fixing hole defined at a free end of the bar.

The door mounting groove 112 may have a connecting portion receiving hole 113 into which the connecting portion 51 is inserted, and the detachable portion 52 may be coupled to the fixing hole inserted into the cabinet 1 via the connecting portion receiving hole 113.

When the door lock 5 is in the state of restraining the door 4, the user is not able to open the inlet 111 because of a restraining force of the door lock 5. However, when the door lock 5 releases the restraint of the door 4, the user may pull the door 4 to open the inlet 111.

Even when the door lock 5 releases the restraint of the door 4, the connecting portion 51 remains inserted into the connecting portion receiving hole 113. That is, even when the coupling between the detachable portion 52 and the connecting portion 51 is released, the door 4 remains fixed to the cabinet 1 with a preset fastening force (a frictional force between the connecting portion, the connecting portion receiving hole, and the detachable portion). Therefore, to open the inlet 111, the user should pull the door 4 with a force equal to or greater than the fastening force.

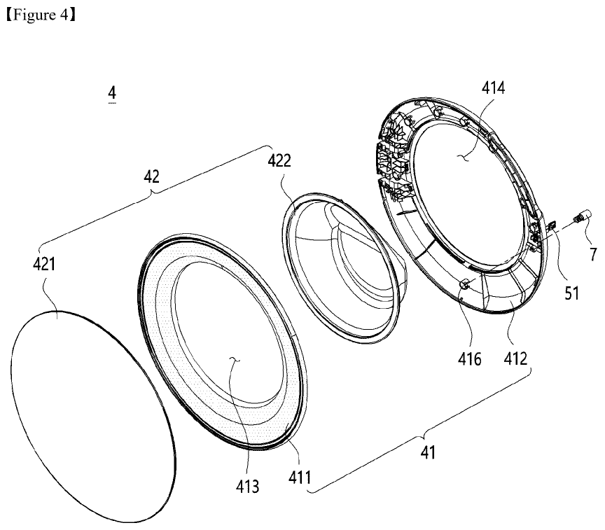

As illustrated in FIG. 4, the door 4 may be constructed to include a frame 41 rotatably fixed to the cabinet 1 via the hinge 14, and a window 42 that is disposed on the frame 41 and enables inside of the drum body 31 to be viewed.

The frame 41 may include a first frame 411 forming the front surface of the laundry treating apparatus 100 together with the front panel 11, and a second frame 412 coupled to the first frame 411 and facing a direction in which the inlet 111 is located.

The connecting portion 51 of the door lock 5 may be formed in a shape of a bar or a board protruding from the second frame 412, and the fixing hole may be defined as a hole extending through the bar or the board.

The window 42 may be constructed to include a cover panel 421 made of a transparent material and fixed to the first frame 411, and an inlet panel 422 made of a transparent material and fixed to the second frame 412.

The first frame 411 may have a first mounting hole 413 closed by the cover panel 421, and the second frame 412 may have a second mounting hole 414 closed by the inlet panel 422. The inlet panel 422 may be formed in a shape that protrudes from the second frame 412 such that at least a partial area thereof is inserted into the inlet 111.

As shown in FIG. 3, the laundry treating apparatus 100 may further include an opening unit (a door opener) 6 that pushes the door 4 such that the inlet 111 is opened when a preset time point is reached.

The preset time point may be set as a time point when a laundry treatment process is completed and the laundry is able to be withdrawn from the drum body 31, or a time point when the laundry treatment process is temporarily suspended and the laundry is able to be withdrawn or inserted.

The door opener 6, as a means for pushing the door 4 in a direction away from the inlet 111 and changing a state of the inlet 111 from the closed state to the open state, may be constructed to include a housing 61 fixed to the inside of the cabinet 1, and an actuator 65 that is withdrawable from the housing 61 and pushes the door 4 in a direction of opening the inlet 111. The door mounting groove 112 may include a panel through-hole 114 that provides a passage through which the actuator 65 is withdrawn to the outside of the cabinet 1.

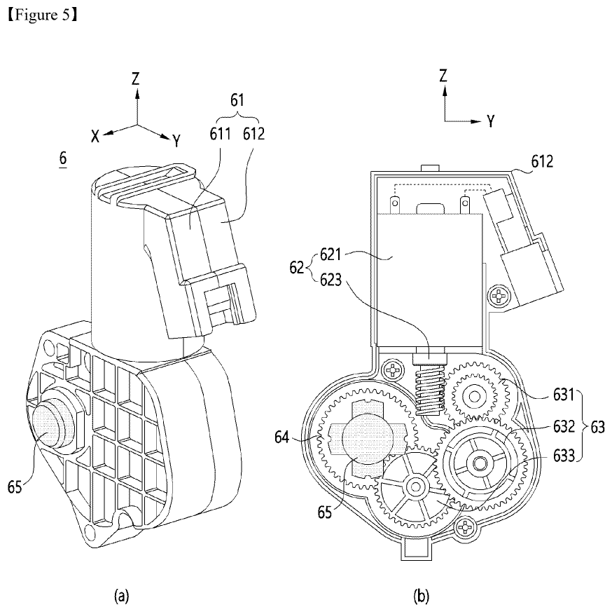

As illustrated in FIG. 5, the housing 51 provides a space in which the actuator 65 and a means 62, 63, and 64 for generating and transmitting power required for operation of the actuator are accommodated. The housing 51 may be composed of a first body 611 and a second body 612.

FIG. 5 illustrates a case in which the means for generating and transmitting the power is constructed as a driving member 62, a driven member 64, and a power transmitter 63 connecting the driving member with the driven member as an example.

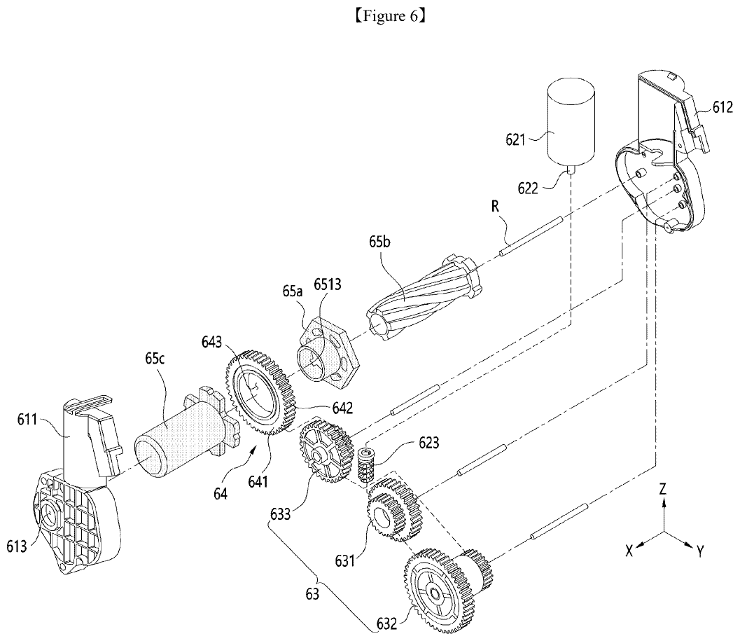

As illustrated in FIG. 6, the driving member 62 may be composed of a motor 621 fixed inside the housing 61, and a driving gear 623 fixed to a rotational shaft 622 of the motor. The driven member 64 may be constructed to include a gear body 641 rotatably fixed inside the housing 61, and multiple gear teeth 642 formed along a circumferential surface of the gear body.

The power transmitter 63 is a connecting gear that transmits a rotational motion of the driving gear 623 to a rotational motion of the gear body 641. The connecting gear may be composed of one gear or multiple gears.

FIG. 6 illustrates a case in which the power transmitter 63 is composed of a first connecting gear 631 that rotates by the driving gear 623, a second connecting gear 632 that rotates by the first connecting gear 631, and a third connecting gear 633 that rotates by the second connecting gear 632. The third connecting gear 633 is disposed to connect the second connecting gear 632 with the gear teeth 642 of the driven member, so that when the motor 621 operates, the gear body 641 of the driven member may rotate inside the housing 61.

The connecting gears 631, 632, and 633 may be constructed to include gears with different diameters. To set a rotation speed of the gear body 641, the number of connecting gears and the diameter of each connecting gear may be set variously.

In FIG. 6, the first connecting gear 631 may include a first gear coupled to the driving gear 623, a second gear having the same center as the first gear, but having a diameter smaller than a diameter of the first gear.

In this case, the second connecting gear 632 may be constructed to include a third gear coupled to the second gear, and a fourth gear having the same center as the third gear, but having a diameter smaller than a diameter of the third gear. The third connecting gear 633 may be constructed to include a fifth gear coupled to the fourth gear, and a sixth gear having the same center of rotation as the fifth gear, but having a diameter smaller than a diameter of the fifth gear and coupled to the gear teeth 642 of the gear body.

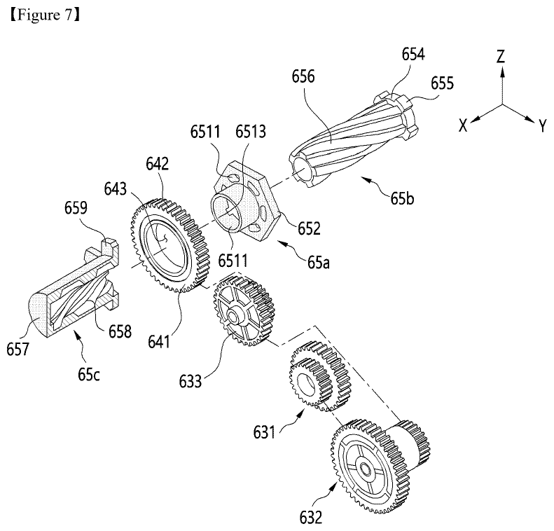

As shown in FIG. 7, the actuator 65 may be constructed to include a protrusion 65b that forms a rotational shaft of the gear body 641 and protrudes from the gear body 641 toward the cabinet (in a +X-axis direction), a fastening portion 65a that couples the protrusion 65b to the gear body 641, and an operating portion 65c that is disposed at a free end of the protrusion 65b and reciprocates between two different points (a first point and a second point) depending on a rotation direction of the protrusion 65b.

As shown in FIG. 6, the housing 61 includes a housing through-hole 613 that is defined to extend through the first body 611 and into which the operating portion 65c is inserted. The housing through-hole 613 is connected to the panel through-hole 114 defined in the door mounting groove 112. Accordingly, depending on the rotation direction of the protrusion 65b, a free end of the operating portion 65c may reciprocate between the first point and the second point that are set in advance.

The first point may be set as a location of the operating portion 65c that causes the door 4 to open the inlet 111, and the second point may be set as a point where the operating portion 65c is not in contact with the door 4 that is in the state of closing the inlet 111. For example, the first point may be set as a point located outside the cabinet 1, and the second point may be set as a point located inside the cabinet 1.

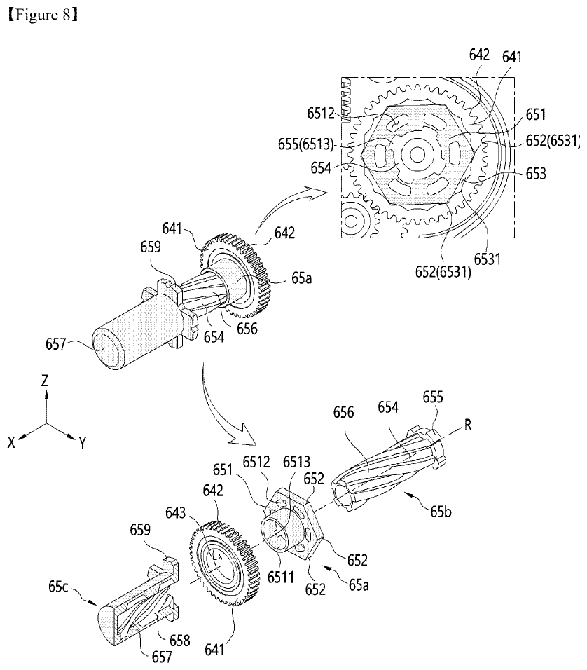

As illustrated in FIG. 8, a gear through-hole 643 through which the protrusion 65b extends may be defined at a center of the gear body 641.

In this case, the fastening portion 65a may be constructed to include a fastening body 651 coupled to the gear body 641, and a body through-hole 6511 extending through the fastening body 651 and connected to the gear through-hole 643.

The protrusion 65b may be constructed to include a protrusion body 654 that is inserted into the body through-hole 6511 and the gear through-hole 643 and positioned on a rotational shaft R of the gear body 641.

Multiple fixing protrusions 655 arranged along a circumferential surface are disposed at one end of the protrusion body 654, and multiple fixing grooves 6513 arranged along a circumferential surface of the body through-hole 6511 and into which the fixing protrusions 655 are respectively inserted may be defined in the fastening body 651. Accordingly, when the fixing protrusions 655 are inserted into the fixing grooves 6513, the protrusion body 654 will be fixed to the fastening body 651.

The operating portion 65c is constructed to include an operating body 657 that is detachably coupled to a free end of the protrusion body 654. An accommodating groove with one surface open is defined inside the operating body 657, and the free end of the protrusion body 654 is inserted into the accommodating groove and coupled to the operating body 657.

A protrusion gear 656 of a male screw structure is disposed on a circumferential surface of the protrusion body 654, and an operating portion gear 658 of a female screw structure to which the protrusion gear 656 may be fastened is disposed inside the accommodating groove of the operating body 657.

When the protrusion body 654 rotates in one of clockwise and counterclockwise directions, the operating body 657 will move in a direction away from the gear body 641 (in a direction away from the fastening body). Therefore, a free end of the operating body 657 may move to the first point.

However, when the protrusion body 654 rotates in the other of the clockwise and counterclockwise directions, the operating body 657 will move toward the gear body 641. Therefore, the free end of the operating body 657 may move to the second point.

To prevent the operating body 657 from being withdrawn from the housing 61, at least one stopper 659 protruding from a circumferential surface of the operating body 657 may be further disposed at one end of the operating body 657.

The laundry treating apparatus having the above-described structure has an effect of hygienically managing the tub 2 and the drum 3 by controlling, by the controller (not shown), the door opener 6 such that the inlet 111 is opened at the preset time point.

However, the door opener 6 equipped only with the above-described structure may be damaged when an external force is input to the operating body 657. That is, when the external force is input to the door 4 while the operating body 657 is supporting the door 4 such that the inlet 111 is maintained in the open state, the operating body 657 will move into the cabinet 1.

When a force to push the operating body 657 toward the cabinet 1 is input, the protrusion body 654 will be forcibly rotated by the operating portion gear 658 and the protrusion gear 656. Because the forced rotation of the protrusion body 654 is transmitted to the gear body 641, the connecting gears 631, 632, and 633, and the driving gear 623, there is a possibility that durability of the door opener 6 may be reduced (breakage of gear teeth or the like).

To solve the above-described problem, the door opener 6 may be equipped to adjust the location of the operating body 657 based on a magnitude of the external force input to the operating body 657. For example, when the external force is transmitted to the operating body 657 as the door 4 moves in the direction of closing the inlet 111, the door opener 6 may be equipped to move the location of the free end of the operating body 657 to the second point.

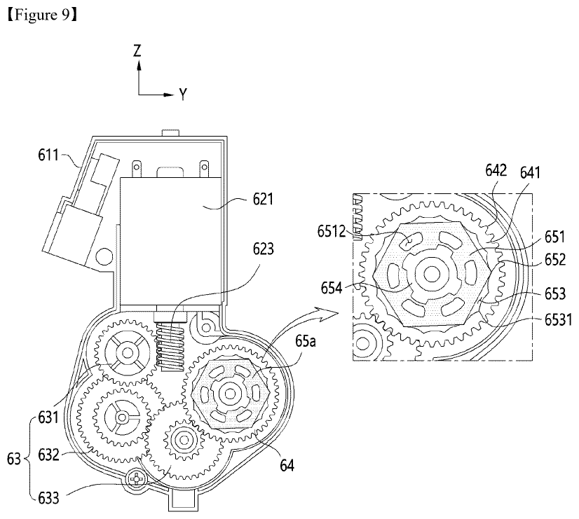

FIG. 9 illustrates, as an example, the actuator 65 that moves the operating body 657 to the second point as the fastening body 651 idles around the gear through-hole 643 when a preset magnitude of the external force is input to the operating body 657 (as the protrusion body idles).

As illustrated in the drawing, the fastening body 651 may be rotatable within a mounting groove 653 defined in a rear surface of the gear body 641. In this case, the fastening portion 65a may be constructed to include a fastening protrusion 652 composed of multiple protrusions arranged along edges of the fastening body 651, and a fastening groove 6531 composed of multiple grooves arranged along edges of the mounting groove 653 and capable of accommodating therein the fastening protrusion 652.

It is preferable that the number of grooves constituting the fastening groove 6531 is set to be greater than the number of protrusions constituting the fastening protrusion 652. FIG. 9 illustrates, as an example, a case in which the fastening protrusion 652 is composed of 6 protrusions spaced apart from each other at an equal spacing along the edges of the fastening body 651, and the fastening groove 6531 is composed of 18 grooves spaced apart from each other at an equal spacing along the edges of the mounting groove 653.

FIG. 9 illustrates, as an example, the fastening body 651 formed in a hexagonal shape and the mounting groove 653 having the same diameter as the fastening body 561, but formed in an 18-gonal shape. A line connecting two neighboring vertices of the mounting groove 653 may be a curved line convex toward a center of the gear body 641. The magnitude of the external force that causes the fastening body 651 to rotate within the mounting groove 653 may be adjusted based on a curvature of the curved line connecting the two neighboring vertices of the mounting groove 653.

A force of the operating body 657 pushing the door 4 (an opening force) is determined by a coupling force of the fastening protrusion 652 and the fastening groove 6531 (a frictional force between the fastening protrusion and the fastening groove). The opening force should be set to be greater than the fastening force set in the connecting portion 51 of the door lock to open the inlet 111.

For the operating body 657 to transmit a force equal to or greater than the fastening force to the door 4, the fastening body 651 should be equipped not to idle when a force greater than the fastening force and equal to or smaller than the opening force is input to the operating body 657, and should be equipped to idle when a force greater than the opening force is input to the operating body 657. That is, the fastening protrusion 652 should be equipped to move from one groove to another neighboring groove constituting the fastening groove 6531 when the force greater than the opening force is input to the operating body 657.

To facilitate the idling of the fastening body 651 when the force greater than the opening force is input to the operating body 657, the fastening body 651 may further include a slit 6512.

The slit 6512 may be composed of multiple holes that extend through the fastening body 651 and are positioned between the protrusion body 654 and the fastening protrusion 652. FIG. 9 illustrates, as an example, a case in which the number of holes in the slit 6512 is equal to the number of protrusions in the fastening protrusion 652.

The slit 6512 facilitates movement of the fastening protrusion 652 in a direction in which the center of the fastening body 651 is located (a direction in which the protrusion body is located). That is, because a magnitude of the opening force may be adjusted by adjusting a length or a width of the slit 6512, the slit 6512 becomes a means for setting the opening force.

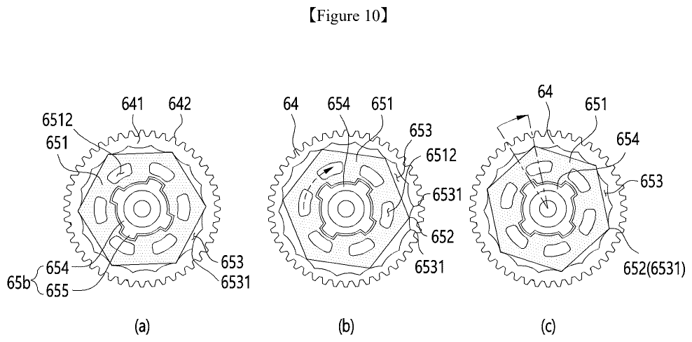

FIG. 10 illustrates a process in which the fastening body 651 rotates within the mounting groove 653, and (a) in FIG. 10 illustrates a state in which the fastening body 651 is coupled to the mounting groove 653. When a great external force is input to the operating body 657 in the state of (a) in FIG. 10, the fastening protrusion 652 will move from one groove to a neighboring groove in the fastening groove 6531 as illustrated in (b) and (c) in FIG. 10.

The laundry treating apparatus 100 equipped with the door opener 6 described above may prevent the tub 2 and the drum 3 from being left in a wet state by opening the inlet 111 at the preset time point.

In addition, because the door opener 6 described above maintains the free end of the operating body 657 exposed to the outside of the cabinet (maintains one end of the operating body withdrawn from the cabinet, maintains one end of the operating body positioned at the first point) when the inlet 111 is opened, the inlet 111 may be maintained in the open state.

In addition, the door opener 6 described above may minimize a possibility of damage to the driving member 62, the power transmitter 63, the driven member 64, and the actuator 65 even when an unintended external force is input to the operating portion 65c via the door 4.

In the laundry treating apparatus 100 described above, when a gap between the door 4 and the inlet 111 is too great, foreign substances may be introduced into the tub 2 and the drum 3.

To solve the above-described problem, the laundry treating apparatus 100 may further include a gap maintainer 7 disposed on at least one of the door 4 and the cabinet 1 to maintain the gap between the inlet 111 and the door 4 (to maintain an opening degree of the inlet equal to or lower than a set reference opening degree). The reference opening degree may be set to be smaller than 10% of an area of the inlet 111.

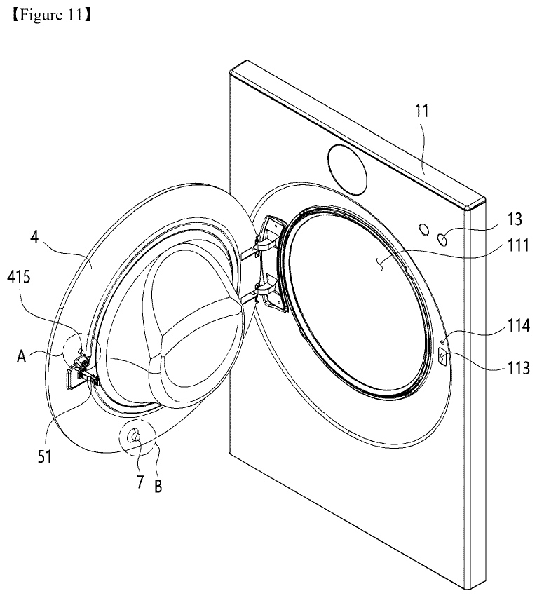

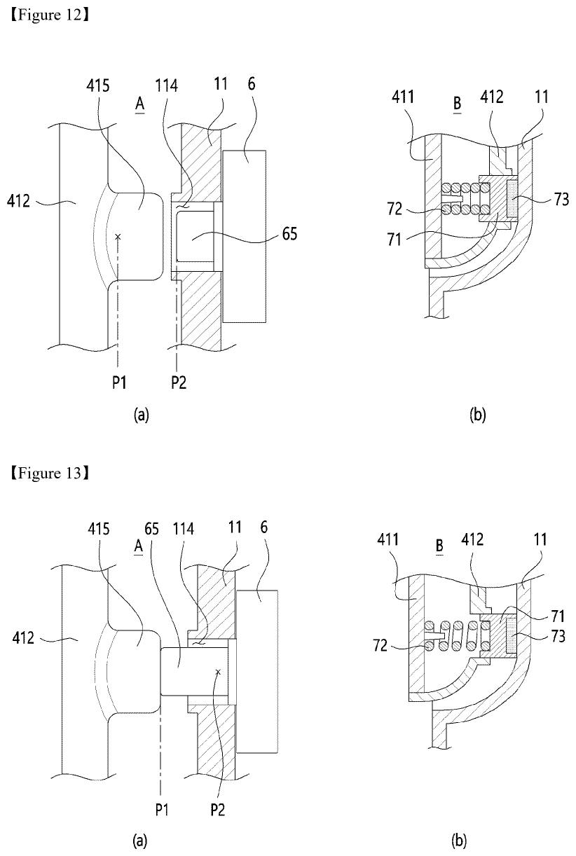

FIG. 11 illustrates a case in which the gap maintainer 7 is disposed on the door 4 as an example. As illustrated in (b) in FIG. 12, the gap maintainer 7 may be constructed to include a spring 72 fixed to the first frame 411 of the door, a mounting body 71 fixed to a free end of the spring 72 and positioned in a frame through-hole 416 (defined to extend through the second frame), and a permanent magnet 73 fixed to one surface of the mounting body 71 facing the front panel 11. The mounting body 71 may reciprocate between the door 4 and the front panel 11 by an elastic force provided by the spring 72.

As shown in (b) in FIG. 12, when the door 4 closes the inlet 111, the mounting body 71 moves into the door 4, so that the spring 72 will be compressed and the permanent magnet 73 will be fixed to the front panel 11 made of a metal material. In this case, the free end of the operating body 657 will be located at a second point P2, as illustrated in (a) in FIG. 12.

In one example, as shown in (a) in FIG. 13, when the free end of the operating body 657 moves to a first point P1 by the operation of the door opener 6, the mounting body 71 will be maintained in the state of being fixed to the front panel 11 by the spring 72 and the permanent magnet 73 as illustrated in (b) in FIG. 13. Therefore, the laundry treating apparatus 100 may maintain the opening degree of the inlet 111 at the reference opening degree.

To implement the function of the gap maintainer 7, a distance at which the door opener 6 pushes the door 7 should be set to a length that does not separate the permanent magnet 73 from the front panel 11.

The door 4 may further include a projection 415 that comes into contact with the operating body 657. The projection 415 may protrude via the panel through-hole 114 on the second frame 412 of the door.

A diameter of the projection 415 may be set to be greater than a diameter of the panel through-hole 114, or may be set to be smaller than the diameter of the panel through-hole 114. In the former case, the first point P1 will be a point located outside the cabinet 1, and the second point P2 will be a point located inside the cabinet 1. In the latter case, both the first point and the second point may be points located inside the cabinet.

As described above, the door opener 6 may be equipped to operate the motor 621 in response to the control signal of the controller (not shown). In this case, the controller (not shown) may control the location of the operating body 657 by controlling the rotation and the rotation direction of the motor rotational shaft 622 at the preset time point.

Unlike the above, the door opening unit 6 may be equipped to operate at a time point desired by the user. To this end, the laundry treating apparatus 100 may further include an operation request unit 13 that receives the control signal required for the operation of the door opening unit 6 from the user. FIG. 11 illustrates a case in which the above-described operation request unit 13 is disposed on the front panel 11 as an example.

The structure and the control method of the laundry treating apparatus described above are for illustration of an example of the present disclosure, so that the scope of the rights of the present disclosure is not able to be limited to the structure and the control method described above.

1. A laundry treating apparatus comprising:
a cabinet having an inlet defined therein;
a treating portion disposed inside the cabinet and constructed to provide a space where laundry is accommodated;
a door disposed on the cabinet and configured to open and close the inlet; and
a door opener constructed be withdrawable from the cabinet and configured to push the door in a direction away from the inlet to change a state of the inlet from a closed state to an open state,
wherein when the inlet is in the open state, the door opener maintains a state of being withdrawn from the cabinet.

2. The laundry treating apparatus of claim 1, wherein when the door moves in a direction of closing the inlet and an external force is input to the door opener, the door opener moves into the cabinet.

3. The laundry treating apparatus of claim 2, further comprising a connecting portion constructed to connect the door with the cabinet with a preset fastening force and configured to allow the opening of the inlet when an external force equal to or greater than the fastening force is input to the door,
wherein the door opener is configured to supply an opening force set to be greater than the fastening force to the door.

4. The laundry treating apparatus of claim 3, wherein when a magnitude of the external force transmitted to the door opener via the door is greater than the opening force, the door opener moves into the cabinet.

5. The laundry treating apparatus of claim 3, further comprising a door mounting groove defined in the cabinet to define a space where one surface of the door is accommodated, wherein the inlet is located in the door mounting groove,
wherein the door opener is located in the door mounting groove.

6. The laundry treating apparatus of claim 5, further comprising:
a connecting portion receiving hole defined to extend through the cabinet and positioned in the door mounting groove; and
a detachable portion disposed inside the cabinet and detachably coupled to the connecting portion inserted into the connecting portion receiving hole.

7. The laundry treating apparatus of claim 2, wherein the door opener includes:
a gear body rotatably fixed inside the cabinet;
a protrusion positioned on a rotational shaft of the gear body, rotatable by the gear body, and protruding from the gear body toward the cabinet;
an operating portion extending through the cabinet and coupled to the protrusion, wherein the operating portion reciprocates between a first point causing the door to open the inlet and a second point causing the door to maintain the inlet closed based on a rotation direction of the protrusion; and
a fastening portion constructed to couple the protrusion to the gear body and configured to allow idling of the protrusion when an external force equal to or greater than a preset magnitude is input to the protrusion.

8. The laundry treating apparatus of claim 7, further comprising a connecting portion constructed to connect the door with the cabinet with a preset fastening force and configured to allow the opening of the inlet when an external force equal to or greater than the fastening force is input to the door,
wherein the fastening portion is configured to supply an opening force (a pushing force) set greater than the fastening force to the door.

9. The laundry treating apparatus of claim 8, wherein when a force equal to or smaller than the opening force is input to the operating portion, the fastening portion is configured to prevent the idling of the protrusion, and
wherein when a force greater than the opening force is input to the operating portion, the fastening portion is configured to allow the idling of the protrusion.

10. The laundry treating apparatus of claim 9, wherein the fastening portion includes:
a mounting groove defined in one surface of the gear body;
a fastening body where the protrusion body is fixed and rotatable within the mounting groove;
a fastening protrusion composed of multiple protrusions arranged along edges of the fastening body; and
a fastening groove composed of grooves arranged along edges of the mounting groove to provide spaces where the protrusions in the fastening protrusion are accommodated, wherein the number of grooves is greater than the number of protrusions in the fastening protrusion.

11. The laundry treating apparatus of claim 10, wherein the protrusions in the fastening protrusion include six protrusions equally spaced apart from each other along the edges of the fastening body, and
wherein the grooves in the fastening groove include 18 grooves equally spaced apart from each other along the edges of the mounting groove.

12. The laundry treating apparatus of claim 10, further comprising a slit defined to extend through fastening body and positioned between the protrusion body and the fastening protrusion.

13. The laundry treating apparatus of claim 7, further comprising:
a door mounting groove defined in the cabinet to define a space where one surface of the door is accommodated, wherein the inlet is located in the door mounting groove; and
a panel through-hole defined to extend through the cabinet and positioned in the door mounting groove, wherein one end of the operating portion is withdrawable from the panel through-hole.

14. The laundry treating apparatus of claim 1, further comprising a gap maintainer disposed on at least one of the door and the cabinet and configured to maintain a gap between the inlet and the door.

15. The laundry treating apparatus of claim 14, wherein the gap maintainer includes a spring fixed to the door; a mounting body fixed to a free end of the spring and configured to reciprocate between the door and the cabinet; and a permanent magnet fixed to one surface of the mounting body facing the cabinet, and
wherein a pushing distance of the door opener for pushing the door is set to a length that prevents the permanent magnet from separating from the cabinet.
